(19) United States
(12) Patent Application Publication
(10) Pub. No.: US 2010/0171933 A1
(43) Pub. Date: Jul. 8, 2010

(54) METHOD FOR COMPENSATING FOR COLOR LOSS OF IMAGE IN IMAGE PROJECTOR AND APPARATUS THEREOF

(75) Inventors: Sung-Soon Kim, Seoul (KR); Byeong-Hoon Park, Suwon-si (KR); Jin-Wook Kwon, Suwon-si (KR)

Correspondence Address: THE FARRELL LAW FIRM, LLP, 290 Broadhollow Road, Suite 210E, Melville, NY, 11747, US

(73) Assignee: Samsung Electronics Co., Ltd.

(21) Appl. No.: 12/652,382

(22) Filed: Jan. 5, 2010

(30) Foreign Application Priority Data
Jan. 5, 2009 (KR) 10-2009-0000300

(51) Int. Cl. G03B 21/20

(52) U.S. Cl. 353/31; 353/121

(57) ABSTRACT

An apparatus is provided for compensating for color loss of an image in an image projector. A light source has Red (R), Green (G) and Blue (B) lamps. An optical image modulator receives R, G and B lights generated in the light source, receives an electrical image signal, modulates the lights according to the image signal, and outputs the lights so that an associated image is projected on a screen. A camera photographs an area on the screen where the image is projected. A lamp driving controller with a color-temperature table, in which optimal brightness setting values of the R, G and B lamps are stored for each screen color, checks brightness setting values of each of the lamps upon receipt of screen color information from the camera. A lamp driver drives each of the lamps in the light source according to control information from the lamp driving controller.

### PRIORITY

This application claims priority under 35 U.S.C. §119(a) to a Korean Patent Application filed in the Korean Intellectual Property Office on Jan. 5, 2009 and assigned Serial No. 10-2009-0000300, the entire disclosure of which is incorporated herein by reference.

### BACKGROUND OF THE INVENTION

1. Field of the Invention

The present invention relates generally to image projectors, and more particularly, to a method and apparatus for compensating for color loss of an image in an image projector or a mobile communication terminal having the image projector as a display device, which projects an image onto the exterior.

2. Description of the Related Art

A device that is capable of projecting an image may project that image in a specific direction or onto a specific place, which is designated by a user. The image projection device displays image data stored in a memory or an image signal received through its image input terminal. The image may be formed on a screen that is installed by the user. A white wall or a plane with any color may also be used as the screen. As such, an image can be formed any place the user wants.

The image projector has different features than those of an internal display device, such as a Liquid Crystal Display (LCD). When using the internal display device, a user can easily change necessary settings, and the internal display device can effectively display the colors of an image according to set values. However, when using an external display device, such as the image projector, the color of an image is significantly influenced by the environment in which the image is projected. For example, the colors are influenced by the brightness of an external light source, the color of the screen, etc. Such projection environments generally have a bad effect on the quality of a projected image. If an image is projected using the same method as in the internal display device, without taking proper measures based on the projection environment, the quality of the projected image may deteriorate. Such problems become more significant in an image projector adapted for mobile environments, such as portable terminals. A mobile communication terminal with an image projector is described in Korean Patent Application No. 2004-29693, tiled on Apr. 28, 2004, and entitled “Portable Terminal with Image Projector and Method for Controlling the Same.”

Color correction technology has been proposed, which corrects the color of an image taking into account the color of the screen at the time the portable image projector projects an image. Such technology is disclosed in Korean Patent Application No. 2006-72773, filed by the applicant of this application on Aug. 1, 2006, and entitled “Image Correction System and Operation Method thereof,” and in Korean Patent Application No. 2006-99871, filed on Oct. 13, 2006, and entitled “Method for Adjusting Image Color in Image Projector and Apparatus thereof.”

The conventional technology is based on correcting color of image data to be displayed on the screen. Therefore, the conventional technology requires complicated computations for correcting image data, which increases the processing time. Image data should be continuously corrected, which continuously consumes resources of a processing unit.

### SUMMARY OF THE INVENTION

The present invention has been made to address at least the above problems and/or disadvantages and to provide at least the advantages described below. Accordingly, an aspect of the present invention provides a method and apparatus for compensating for color loss of an image in an image projector, which can display a high-definition image with an influence of a background color removed without wasting resources of a processing unit.

According to one aspect of the present invention, an apparatus is provided for compensating for color loss of an image in an image projector. The apparatus includes a light source having Red (R), Green (G) and Blue (B) lamps. The apparatus also includes optical image modulator that receives R, G and B lights generated in the light source, receives an external electrical image signal, modulates the R, G and B lights according to the external electrical image signal, and outputs the modulated R, G and B lights so that an associated image is projected onto a screen. The apparatus further includes a camera that photographs a projection area on the screen where the associated image is projected, and outputs screen color information. The apparatus additionally includes a lamp driving controller with a color-temperature table, in which optimal brightness setting values of the R, G and B lamps are previously stored for each screen color, that checks brightness setting values of the R, G and B lamps upon receipt of the screen color information from the camera, and outputs control information associated with the brightness setting values. The apparatus also includes a lamp driver that drives each of the R, G and B lamps in the light source according to the control information from the lamp driving controller.

According to another aspect of the present invention, a method is provided for compensating for color loss of an image in an image projector. Screen color information is collected by photographing a projection area on a screen. A screen color is recognized from the photographed projection area. Setting values of Red (R), Green (G) and Blue (B) lamps, which are determined according to the recognized screen color, are derived based on a preset color-temperature table. A respective brightness of each of the R. G and B lamps in a light source are set according to the derived setting values of the R, G and B lamps. The R, G and B lamps in the light source are driven according to the respective brightness of each of the R, G and B lamps.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a schematic block diagram illustrating an image projector with an image color loss compensation device, according to an embodiment of the present invention; and

FIG. 2 is a flowchart illustrating an image color loss compensation operation of an image projector, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

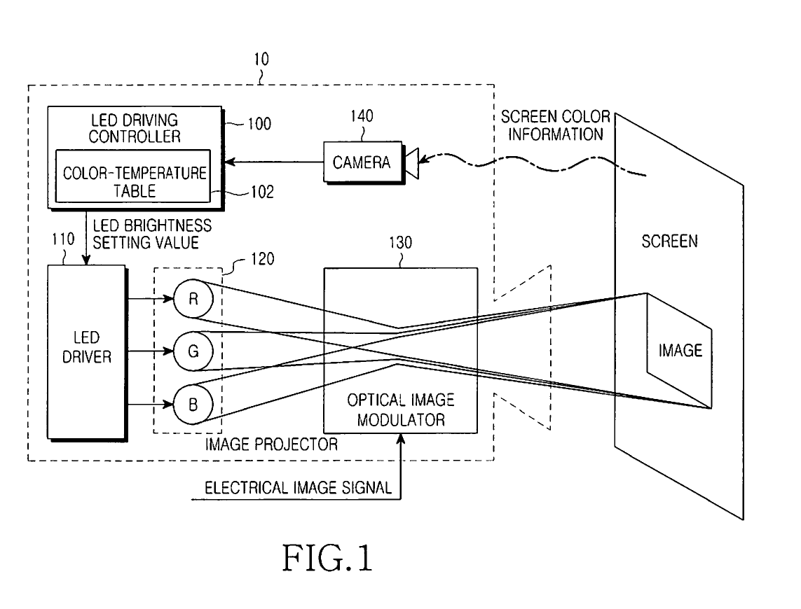

Referring initially to FIG. 1, a diagram illustrates a schematic structure of an image projector with an image color loss compensation device, according to an embodiment of the present invention. An image projector 10, according to an embodiment of the present invention, includes three color lamps (commonly, Light Emitting Diodes (LEDs)) of Red (R), Green (G) and Blue (B), which are used for a light source 120. Thus, the image projector 10 does not have a single white light source and a color filter. The light source 120 is driven by a lamp driver (or LED driver) 110 and emits visible lights of three R, G and B colors. The generated R, G and B lights are provided to an optical image modulator 130. The optical image modulator 130, which commonly includes Digital Light Processing (DLP) or Liquid Crystal On Silicon (LCOS), receives an electrical image signal provided from an external personal computer (or a mobile communication terminal when the image projector 10 is applied to the mobile communication terminal). The optical image modulator modulates the R, G and B lights according to the received electrical image signal, and outputs the modulated R, G and B lights so that a related image is projected on a screen.

A camera 140 is provided in the image projector 10. The camera 140 photographs a projection area on the screen upon which an image is projected. The camera 140 acquires color information of the screen, and outputs screen color information. The camera 140 may output color information of the photographed image signal in R, G and B values. The screen color information output from the camera 140 is provided to a lamp driving controller (or LED driving controller) 100, which is designed according to an embodiment of the present invention.

The lamp driving controller 100 has a preset color-temperature table 102, in which optimal brightness setting values of R, G and B LEDs (or R, G and B lights) are previously stored for each screen color. Upon receiving the screen color information, the lamp driving controller 100 checks the optimal brightness setting values of R, G and B LEDs for the current screen color in the color-temperature table 102. The lamp driving controller then provides control information associated therewith to the lamp driver 110. Based on the control information, the lamp driver 110 sets a brightness of each of the R, G and B LEDs by properly setting a driving current for each of the R, G and B LEDs in the light source 120.

The image projector with an image color loss compensation device, according to an embodiment of the present invention, adjusts the brightness of each of the R, G and B lights so that the color of an image may be optimized to the current screen color. Thus, the image may be projected on the screen in an optimal state.

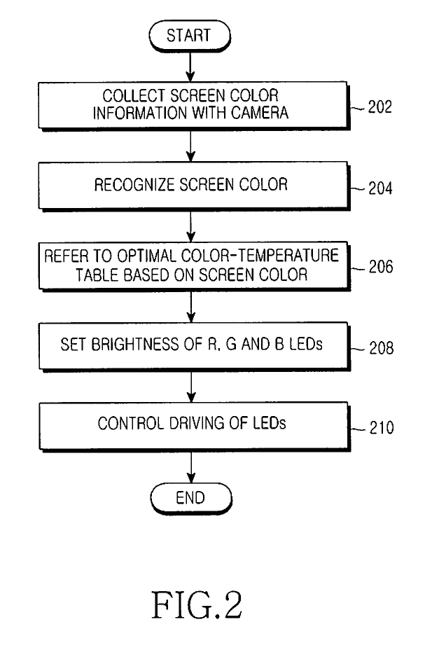

Referring now to FIG. 2, a flowchart illustrates an image color loss compensation operation of an image projector, according to an embodiment of the present invention. When starting image projection, the image projector collects screen color information by photographing a projection area on a screen using a camera in step 202. In step 204, the image projector recognizes a color of the screen based on the photographed image information. The image projector divides an image signal into R, G and B signals, and determines color information of the screen in RGB values. In step 206, the image projector derives optimal R, G and B setting values associated with the screen color by referring to a preset color-temperature table. In step 208, the image projector sets a brightness of R, G and B LEDs in its light source according to the optimal R, G and B setting values. In step 210, the image projector projects an image by controlling an LED driver.

As is apparent from the foregoing description, an image color loss compensation scheme of an image projector, according to embodiments of the present invention, is simpler and can display a high-definition image without being influenced by a background color. Further, resources of a processing unit are not wasted, since color correction on image data is not required.

While it has been described that a camera is provided in an image projector, according to an embodiment of the present invention, if the image projector of the present invention is provided in a mobile communication terminal, the image projector may use a camera embedded in the mobile communication terminal. The image projector, according to an embodiment of the present invention, may also be applied to the ordinary portable image projector. The image projector may further include a light source adjusting switch used to manually receive color and/or brightness of each of the R, G and B LEDs in the light source from a user, and may also include a structure for adjusting color and/or brightness of the R, G and B LEDs in the light source according to the received control information.

While the invention has been shown and described with reference to certain embodiments thereof, it will be understood by those skilled in the art that various changes in form and detail may be made therein without departing from the spirit and scope of the invention as defined by the appended claims and their equivalents.

What is claimed is:

1. An apparatus for compensating for color loss of an image in an image projector, comprising:
a light source having Red (R), Green (G) and Blue (B) lamps;
an optical image modulator for receiving R, G and B lights generated in the light source, receiving an external electrical image signal, modulating the R, G and B lights according to the external electrical image signal, and outputting the modulated R, G and B lights so that an associated image is projected onto a screen;
a camera for photographing a projection area on the screen where the associated image is projected, and outputting screen color information;
a lamp driving controller with a color-temperature table, in which optimal brightness setting values of the R, G and B lamps are previously stored for each screen color, for checking brightness setting values of the R, G and B lamps upon receipt of the screen color information from the camera, and outputting control information associated with the brightness setting values; and
a lamp driver for driving each of the R, G and B lamps in the light source according to the control information from the lamp driving controller.

2. The apparatus of claim 1, wherein the optical image modulator comprises at least one of Digital Light Processing (DLP) and Liquid Crystal On Silicon (LCOS).

3. The apparatus of claim 1, further comprising a light source adjusting switch used to manually receive color and/or brightness of the light source from a user;
wherein the lamp driving controller controls driving of the light source according to an input from the light source adjusting switch.

4. A method for compensating for color loss of an image in an image projector, comprising the steps of:
collecting screen color information by photographing a projection area on a screen;
recognizing a screen color from the photographed projection area;
deriving setting values of Red (R), Green (G) and Blue (B) lamps, which are determined according to the recognized screen color, based on a preset color-temperature table;
setting a respective brightness of each of the R, G and B lamps in a light source according to the derived setting values of the R, G and B lamps; and
driving the R, G and B lamps in the light source according to the respective brightness of each of the R, G and B lamps.
